(19) United States
(12) Patent Application Publication
(10) Pub. No.: US 2003/0151182 A1
(43) Pub. Date: Aug. 14, 2003

(54) Plate-like element retaining suction cup for glass working machines

(75) Inventor: Franco Bavelloni, San Fermo Della Battaglia (IT)

Correspondence Address: MODIANO & ASSOCIATI, Via Meravigli, 16, MILANO, 20123, IT

(73) Assignee: Z. BAVELLONI S.p.A.

(21) Appl. No.: 10/270,355

(22) Filed: Oct. 15, 2002

(30) Foreign Application Priority Data
Feb. 12, 2002 (IT) MI2002A000266

(51) Int. Cl. B25B 11/00

(52) U.S. Cl. 269/21

(57) ABSTRACT

A suction cup element for retaining plate-like elements, particularly for machines for working glass plates and the like, which comprises a suction cup body provided with a lower suction cup and an upper suction cup that delimit regions connected to a lower intake duct and to an upper intake duct, respectively, for connection to a vacuum source. A flow control element is further provided for controlling the lower intake duct so as to free the connection to the region delimited by the lower suction cup when the suction cup element is rested on the working surface.

### BACKGROUND OF THE INVENTION

The present invention relates to a suction cup element for retaining plate-like elements, particularly for machines for working glass plates and the like.

It is known that machines for working glass plates in particular, and other sectors in which it is necessary to retain plate-like elements, currently use suction cup elements that are arranged on the working surface and are designed to retain firmly in position the plate-like element on which the different treatments are to be performed.

The suction cup elements, in their classic embodiment, are provided by means of a suction cup body having a lower suction cup and an upper suction cup, which delimit regions that are respectively connected to a lower intake duct and to an upper intake duct for connection to a source of vacuum.

In practical use, it is therefore currently necessary to position precisely the suction cup at the intended point of the working surface and before releasing the suction cup it is necessary to connect the lower region to the vacuum source, so that the suction cup practically performs a locking on the working surface.

With this type of suction cup element it is not possible to use spiral intake ducts, because they would produce a recoil on the body which might displace it, and it is therefore necessary to provide, in each instance, portions of intake hose whose length is approximately equal to the distance between the suction cup element and the distribution unit connected to the vacuum source.

In the current situation, therefore, it is necessary to perform a long series of operations, and in particular the operator must sequentially position the suction cup on the surface and then connect it to the vacuum source so as to lock it on the surface and proceed with the subsequent operations.

Clearly, this approach causes considerable hindrance and most of all requires acting on the vacuum distribution unit every time a suction cup is positioned, with obvious problems when the suction cups are distant from the vacuum distribution unit.

### SUMMARY OF THE INVENTION

The aim of the present invention is to eliminate the drawbacks mentioned above, by providing a suction cup element for retaining plate-like elements, particularly for machines for working glass plates and the like, that allows to automatically connect the region delimited by the lower suction cup to the vacuum source when the suction cup is positioned on the working surface, without having to perform a separate actuation.

Within this aim, an object of the invention is to provide a suction cup element that allows to use spiral or coiled suction hoses and thus allows to have a reduced variety of hose types to cover all placement distances.

Another object of the present invention is to provide a suction cup element that simplifies considerably all the steps for positioning the suction cup element, freeing the operator from the need to act on the distribution unit connected to the vacuum sources during every positioning operation.

Another object of the present invention is to provide a suction cup element that can be obtained easily starting from commonly commercially available elements and materials and is further competitive from a merely economical standpoint.

This aim and these and other objects that will become better apparent hereinafter are achieved by a suction cup element for retaining plate-like elements, particularly for machines for working glass plates and the like, according to the invention, which comprises a suction cup body provided with a lower suction cup and an upper suction cup that delimit regions that are respectively connected to a lower intake duct and to an upper intake duct for connection to a vacuum source, characterized in that it comprises control means for controlling said lower intake duct which are adapted to free the connection to the region delimited by said lower suction cup when the suction cup element is rested on the working surface.

### BRIEF DESCRIPTION OF THE DRAWINGS

Further characteristics and advantages will become better apparent from the following detailed description of a preferred but not exclusive embodiment of a suction cup element for retaining plate-like elements, particularly for machines for working glass plates and the like, illustrated only by way of non-limitative example in the accompanying drawings, wherein:

FIG. 1 is a partially sectional view of the suction cup element before positioning it on the working surface;

FIG. 2 is a view of the suction cup element placed on the working surface;

FIG. 3 is a view of a different embodiment of the control means for controlling the lower intake duct.

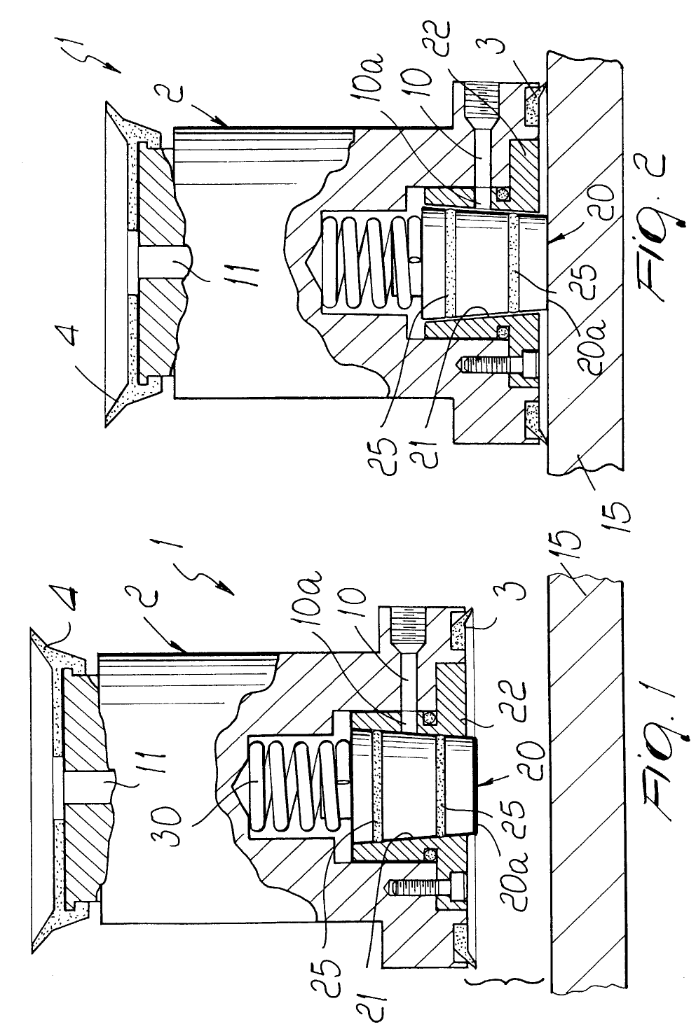

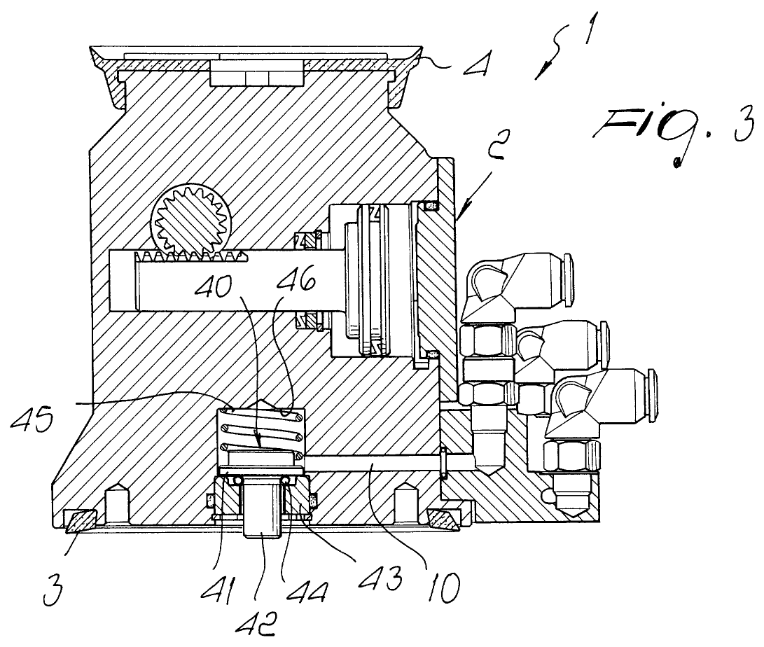

### DESCRIPTION OF THE PREFERRED EMBODIMENTS

With reference to the figures, the suction cup element for retaining plate-like elements, particularly for machines for working glass plates and the like, generally designated by the reference numeral 1, comprises a suction cup body 2 which typically has a lower suction cup 3 and an upper suction cup 4, which delimit regions connected to a lower intake duct 10 and to an upper intake duct 11.

The ducts 10 and 11 can be connected in a manner known per se to a source of vacuum provided by the machine in which the suction cup elements are used.

The particularity of the invention consists that control means are provided for controlling the lower intake duct, in particular the suction flow, and are suitable to free the connection to the region delimited by the lower suction cup 3 when the suction cup element is rested on the working surface 15.

In a preferred but non-limitative embodiment, the control means provide for a flow control element 20, such as a plug or piston which is frustum-shaped and is accommodated in a frustum-shaped seat 21 formed by a ring 22 that defines a passage or connecting portion 10a for the connection of said seat 21 to the lower intake duct.

The ring 22 is accommodated hermetically and fixed at the lower face of the suction cup body 2 and accommodates the flow control element 20, which is provided with two sealing gaskets 25, which are arranged in practice so as to straddle the opening of the connector 10a for connection to the lower intake duct.

There are also elastic pusher means, constituted by a spring 30 that pushes the flow control element 20 so as to form a seal within the seat 21.

The flow control element 20 is sized so that it has a lower face 20a that protrudes with respect to the lower face of the suction cup body, thereby when the suction cup body 2 is applied to the working surface 15, the suction cup body's own weight causes a translational motion of the flow control element 20 which frees the connection to the intake duct 10, so that the locking of the suction cup element on the working surface is activated automatically.

With reference to FIG. 3, the control means comprise a plate-type flow control element 40, which has a portion shaped like a flange 41 that is connected to a stem 42 that protrudes downward from a bush-like ring 43 that is connected hermetically to the suction cup body 2.

The flange-shaped portion has a front gasket 44 for forming a seal around the hole for the passage of the stem 42, and is pushed elastically by a pusher spring 45, which acts on the bottom of the recess 46 that accommodates the flow control element and is connected to the intake duct 10.

Resting the suction cup element on the working surface causes the translational motion of the stem 42 and the consequent spacing of the flange 41 with respect to the gasket 44, and therefore the locking of the suction cup element on the working surface is activated automatically.

Obviously it is possible to use other types of valve to obtain the connection to the vacuum source for the lower suction cup element, so that when the suction cup element is released in the intended position it locks in position immediately, since the connection to the vacuum source is activated instantaneously.

This embodiment is very useful in all kinds of glass working machines and particularly for machines that have automatic means for positioning the suction cup element.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements.

The disclosures in Italian Patent Application No. MI2002A000266 from which this application claims priority are incorporated herein by reference.

What is claimed is:

1. A suction cup element connectable to a vacuum source for retaining plate elements by resting on a working surface thereof, in a glass working machine, comprising: a lower intake duct; an upper intake duct; a suction cup body, provided with a lower suction cup and an upper suction cup that delimit regions of said body that are connected to said lower intake duct and to said upper intake duct, respectively, for connection to the vacuum source;
and control means for controlling said lower intake duct, said control means being operatable to free duct connection to the body region delimited by said lower suction cup when the suction cup element is rested on the working surface.

2. The suction cup element of claim 1, wherein said control means comprise: a seat, provided at the body region delimited by said lower suction cup; and a flow control element for controlling flow through said lower intake duct, said flow control element having a lower end that protrudes with respect to a lower face of said suction cup body and being movable in said seat in order to free said lower intake duct when the suction cup element is rested on the working surface.

3. The suction cup element of claim 2, wherein said seat is formed by a ring connected to the lower face of said suction cup body and provided with a connecting portion for connecting said seat to said lower intake duct, said flow control element being accommodated within said seat.

4. The suction cup element of claim 3, further comprising, two sealing gaskets, provided on said flow control element so as to straddle a connection of said seat region to said connecting portion.

5. The suction cup element of claim 2, comprising elastic means that act on said flow control element in order to push the lower end thereof to protrude out from the lower face of said suction cup body.

6. The suction cup element of claim 4, wherein said flow control element is substantially frustum-shaped.

7. The suction cup element of claim 1, wherein said control means comprise a plate-type flow control element that has a portion shaped as a flange; a bush-like ring that is connected hermetically to said suction cup body and has a passage hole; a stem provided at said flange-shaped portion so as to perform a translational motion, said stem protruding downward from said bush-like ring; a front sealing gasket, supported by said flange-shaped portion, and acting around the hole for the passage of said stem.

8. The suction cup element of claim 7, further comprising a recess accommodating said plate-type flow element which has a bottom; and a pusher spring that acts between said flange-shaped portion and the bottom of the recess that accommodates said plate-type flow control element.
